(19) United States
(12) Patent Application Publication
(10) Pub. No.: US 2014/0195546 A1
(43) Pub. Date: Jul. 10, 2014

(54) Selective Push System For User Data And Confidential Information Management With High Precision Matching

(71) Applicant: Tom Yitao Ren, Bellaire, TX (US)

(72) Inventor: Tom Yitao Ren, Bellaire, TX (US)

(21) Appl. No.: 13/717,728

(22) Filed: Dec. 18, 2012

Related U.S. Application Data
(60) Provisional application No. 61/577,414, filed on Dec. 19, 2011.

(51) Int. Cl. G06F 17/30

(52) U.S. Cl. CPC G06F 17/3053
USPC 707/748; 707/758

(57) ABSTRACT

A computer implemented selective push system and method for user data and confidential information management with high precision matching based on user-defined values. The process is carried out by a user using a computer having a central processor unit, memory, a graphics user interface, input device, and communication device. A user enters and ranks data and information and selected targeted destinations to which data and information is to be submitted; the system analyzes and confirms the entered data and information, locates and matches destinations, and pushes the data and information to the highest ranked target destinations defined by the user, and generates a notification of the submission to the user. The user may define pushing times, dates, priorities, importance, customize data submission options, and history and retention and forwarding options, and specify which data elements are confidential to selected target destinations and for selected purposes.

### CROSS REFERENCE TO RELATED APPLICATION

This application claims the benefit and priority of U.S. Provisional Patent Application Ser. No. 61/577,414, filed on Dec. 19, 2011, the disclosure of which is hereby incorporated entirely herein by reference.

### BACKGROUND OF THE INVENTION

1. Field of the Invention

This invention relates generally to computer-driven and implemented information management systems and, more particularly, to a computer-driven and implemented selective push system for user data and confidential information management system with high precision matching based on user-defined values.

2. Background Art

As used herein, the terms “Web Site”, “Web page”, “Site”, “Location”, and “Destination” refer to desired Internet Web Sites or other destinations to which the data and information is to be sent. The term “Destination” may also include third-party email recipients, mobile apps and cell phones. As used herein, the terms “push” and “push technology” refer to a Web-based data distribution technology in which selected data are automatically delivered to a receiver location (Web Site, computer, server) at prescribed intervals or based on some event that occurs. Email messages are an example of push technology. In contrast, “pull” and “pull technology” refer to a Web-based system wherein a user specifically requests data or information by performing a search of various locations (Web Sites, etc.). Browsing the Web is an example of pull technology.

With the overwhelming usage of the Internet comes the problem of the information provider deciding how and where to direct the information so as to be received by those who are most likely to be interested from the standpoint of the provider.

Typically, in order to provide data and information those who are most likely to be interested, the information provider must undertake the extremely time consuming, labor intensive, and redundant task of manually navigating through the Internet to visit sites which may or may not be of interest, and repeatedly create a profile, complete forms, and submit the appropriate information. From a security standpoint, the information provider usually has no control over what data elements are confidential to selected Web Sites (or destinations) and for what purposes, and it is difficult to maintain records of when and what data has been released or revealed to each entity.

My pending U.S. patent application, Ser. No. 13/088,235 (Publication No. 2011/0258083), discloses a system and method for providing an efficient and simple procurement process that is easily customizable and allows the automatic mapping of supplier information and catalogs according to the buyer/purchasing organization's internal data schema used for representing such data, and updates the buyer/purchasing organization's hosted supplier information and catalogs automatically. In an exemplary embodiment, access to an electronic procurement system is requested, a supplier provides supplier data through a graphical user interface (GUI) for storage in one or more databases of an electronic procurement system, the supplier designates a subset of the supplier data as protected supplier data, and conveniently selects one or more buyer organization's supplier management systems to receive the provided supplier data.

My previous U.S. Pat. No. 7,587,377 discloses a computer driven information management system that selectively ranks and qualifies third-parties, such as vendors, by utilizing user-defined and selected questions and qualification criteria from various data sources to utilize the database information available in public, commercial or in private, or by information directly supplied by the third-party in a registration with the organization desiring information from the third-party. The system displays the results of the scoring system for user selection. Alternatively, the system can automatically generate a notification of selection to the organization, the user and the third-party from whom the information was obtained.

### SUMMARY OF THE INVENTION

The present invention overcomes the aforementioned problems and is distinguished over the prior art in general, and these patents in particular, by a computer-driven and implemented selective push system, process and method for user data and confidential information management with high precision matching based on user-defined values. The process is carried out by a user (or administrator) using a general purpose network accessible computer workstation having a central microprocessor unit with a memory component, a graphical user interface coupled with the microprocessor, a user input device such as a keyboard, pointing device or touch screen coupled with the microprocessor operable by a user for inputting data, a monitor coupled with the microprocessor for displaying graphics and data, a communications device coupled with the microprocessor for communication with the World Wide Web, Internet Web Sites, local and/or remote networks, local and/or remote servers, wireless and/or cellular networks, third-parties and other destinations to which information is to be sent.

The system includes a user interface and a push system wherein during an initialization stage it requires users (or administrators) to enter specific data and information and select targeted Web Sites (locations) to which data and information is to be submitted; and during an execution stage, analyzes and confirms the user entered data and information, locates and matches Web Site destinations, and processes and pushes the data and information to the highest ranked Web Sites defined by the user, and generate an email notification of the submission to the user. The user (or administrator) may create and save multiple profiles at the user interface, for different purposes and for pushing to different Web Sites (or destinations). The user also has the option to define detailed data pushing times, dates, and priorities, and customize data submission options and history and retention and forwarding options. After building a profile, the user may email a link to the profile to anyone, with selected sections being password protected, and selected sections for public view. The system may build user profiles based on selected data and information entered both by users that are seeking to push information to a recipient, and by recipients that are seeking to receive selected data and information. Both types of users may use the same system to define and rank which selected data and information is to be pushed, or received, and may rank and score potential recipients according to self-defined priority and importance rules determined by the user.

In a preferred embodiment, present system allows the user (or administrator) to specify which data elements are confidential to selected Web Sites (or destinations) and for selected purposes, and to create scoring values and rules to provide that certain data can never be revealed and can only be scored, and that certain data can be revealed sequentially when meeting certain score values and criteria, etc. The system will also record when and what data has been released or revealed to each entity. The confidential data can be saved locally and/or remotely, such as by cloud storage.

One of the significant features and advantages of the present invention is that it provides efficient data presentation that would otherwise be extremely time consuming, labor intensive, redundant or impractical.

Another feature and advantage of the present invention is that it allows a user to create and maintain one or more profiles that can be customized to match each and all requirements of selected targeted Web Sites (or destinations) to which data and information is to be submitted.

Another feature and advantage of the present invention is that it allows the user (or administrator) to specify which data elements are confidential to selected Web Sites (or destinations) and for selected purposes, and to create scoring values and rules to provide that certain data can never be revealed and can only be scored.

Another feature and advantage of the present invention is that the push system may build user profiles based on selected data and information entered both by users that are seeking to push information to a recipient, and by recipients that are seeking to receive selected data and information. Both types of users may use the same system to define and rank which selected data and information is to be pushed, or received, and may rank and score potential recipients according to self-defined priority and importance rules determined by the user.

A still further feature and advantage of the present invention is that it may be used for any information pushing requirement such as, for example but not limited to: individuals desiring to apply at a university, applications for employment, registration of business suppliers, government agencies sending contractor solicitations, and individuals sending profile information and initiating contact with others seeking matching personal interests, e.g. dating matching, or the like.

Other features and advantages of the invention will become apparent from time to time throughout the specification and claims as hereinafter related.

### BRIEF DESCRIPTION OF THE DRAWINGS

FIG. 1 is a block diagram illustrating a general overview of the steps in the process, method and system of the present invention.

FIG. 2 is a block diagram illustrating the functionality of the user interface and an example of the data and information entry and destination selection process.

FIG. 3 is a block diagram illustrating the functionality of the present system in analyzing and confirming the user entered data and information, locating and matching destinations, and processing and pushing the data and information.

FIG. 4 is a block diagram illustrating the overall functionality of the user side and processor side of the selective push system.

FIG. 5A is a block diagram illustrating an example of the type of information that may be entered at the user interface by a business owner attempting to sell a company, and push certain data sequentially and automatically to potential acquirers who meet the business owner's requirements and the acquirer's desires.

FIG. 5B is a block diagram illustrating an example of the type of information that may be entered at the user interface by a manufacturer attempting to sell a product, and push certain data sequentially and automatically to potential acquirers who meet the manufacturer's requirements and the acquirer's desires.

FIG. 6 is a block diagram illustrating an example of how the system may build user profiles based on selected data and information entered by several information providers.

FIG. 7 is a chart showing an example of the results of the ranking and scoring routine in a situation where the user wanted to locate a potential buyer for his company or product.

FIG. 8 is a chart showing an example of the results of a self-defined ranking and scoring routine where the user wants to locate a potential buyer for his company or product and he defines the conditions of the data sets and ranks them according to “Priority” and “Importance”.

FIG. 9 are charts showing examples of the results of a self-defined ranking and scoring routine of a prospective supplier or buyer of a product according to “Priority”, “Importance”, considering “Priority” first, and further calculating the profit potential resulting from selling or buying the products.

### DESCRIPTION OF THE PREFERRED EMBODIMENT

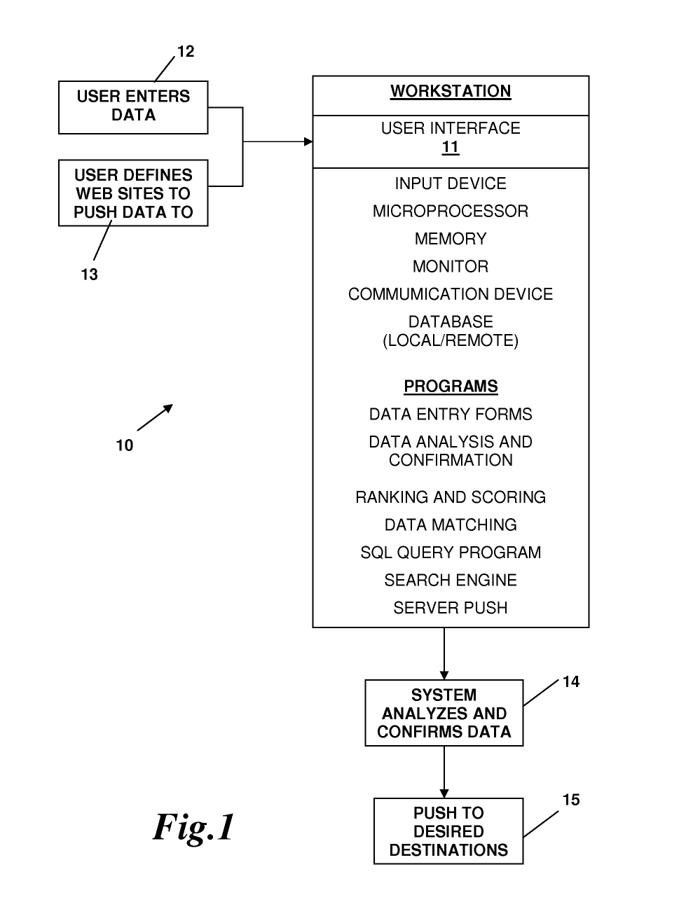

It should be understood that some of the operations of the present computer-driven and implemented selective push system for user data and confidential information management system is carried out by a user (or administrator) using a general purpose network accessible computer workstation, as shown in FIG. 1. The workstation 10 has a central microprocessor unit with a memory component, a graphical user interface 11 coupled with the microprocessor, a user input device such as a keyboard, pointing device or touch screen coupled with the microprocessor operable by a user for inputting data, a monitor coupled with the microprocessor for displaying graphics and data, a communications device coupled with the microprocessor for communication with the World Wide Web, local networks and Internet Web Sites. The microprocessor is equipped with executable programs for generating data entry forms, and carrying out functions of data analysis and confirmation, ranking and scoring, data matching, SQL queries, a search engine, and server push operations.

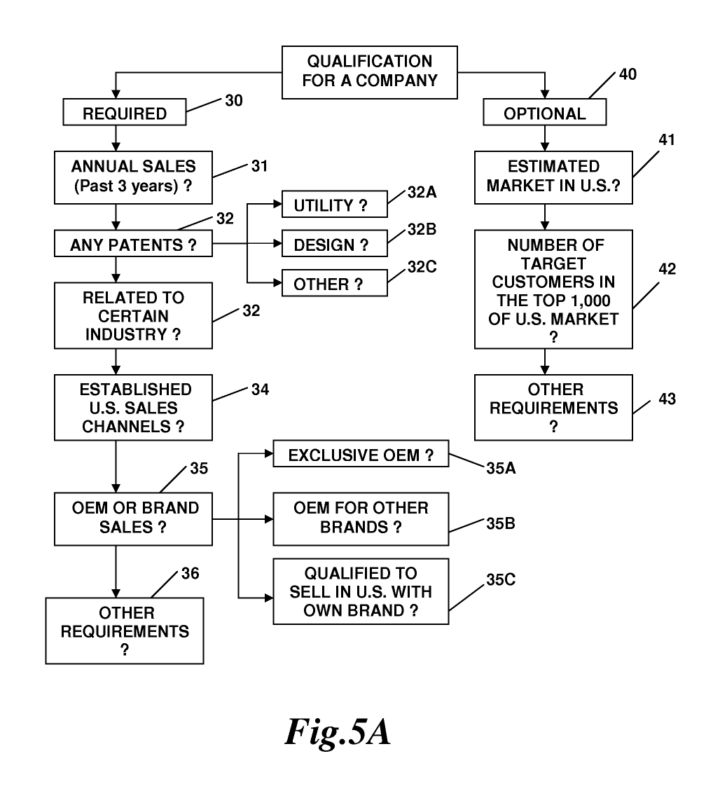

FIGS. 1 and 4 illustrate a general overview of the system and method of the present invention. A user (or administrator) using the user interface 11 enters data and information 12, builds a user profile, defines, ranks Web Sites (or destinations) 13 to which selected data and information is to be pushed, and saves the entered data in a database in the central processor unit memory. The user interface 11 may prompt or query the user (or administrator) for the requisite data and information to be entered. The push system analyzes and confirms the user entered data and information 14, locates and matches Web Site destinations, and processes and pushes the data and information to the highest ranked Web Sites defined by the user 15. The user (or administrator) may create and save multiple profiles at the user interface, for different purposes and for pushing to different Web Sites (or destinations).

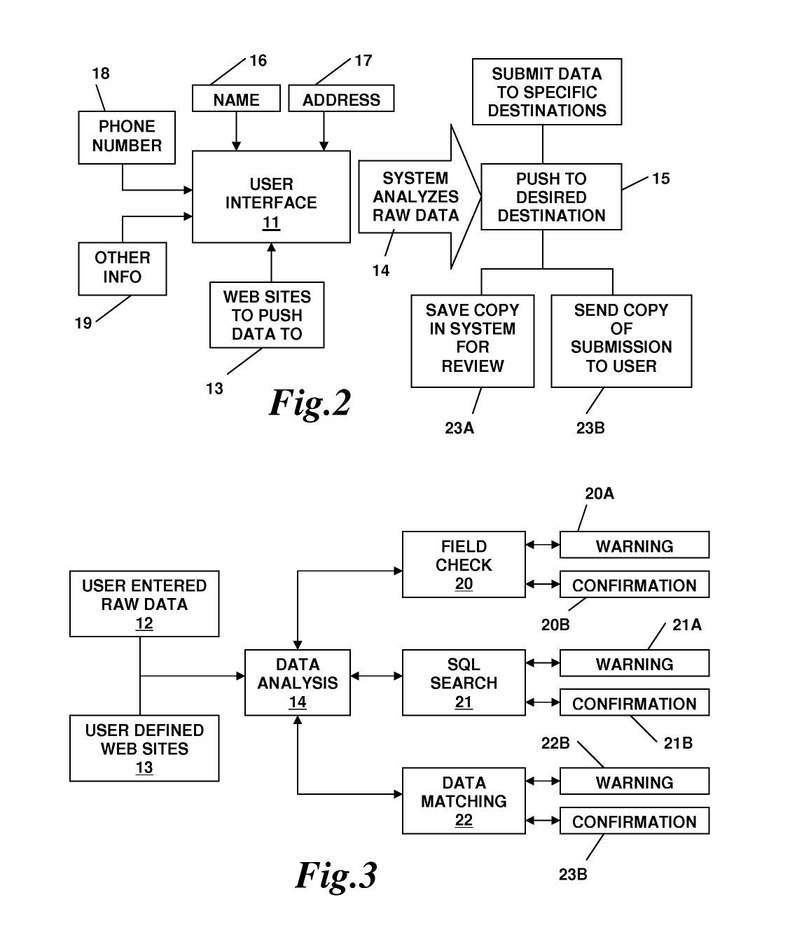

FIG. 2 illustrates an example, but not limited thereto, of the type of information that may be entered at the user interface 11. In this example, the user interface 11 may present a student submitting an application for enrollment at a university with a data entry form with standard and/or customized data fields for entering basic personal information such as name 16, address 17, phone number 18, and all of any other user specified information 19, such as date of birth, test scores, major, certifications, recommendation letters, fee payments, etc. if the user doesn't require customized input. It should be understood that this example is presented for purposes of example only, and that data entry fields of the user interface 11 is not limited those described. The user (or administrator) also enters, and identifies the Web Sites (or destinations) to which the data is to be pushed 13. The Web Sites (or destinations) can be defined and ranked by the user, search engine, or any other third party tools. The user also has the option to define detailed data pushing times, dates, and priorities, and customize data submission options and history and retention and forwarding options.

In a preferred embodiment, present system allows the user (or administrator) to specify which data elements are confidential to selected Web Sites (or destinations) and for selected purposes. For example, the user (or administrator) may create scoring values and rules to provide that certain data can never be revealed and can only be scored, and that certain data can be revealed sequentially when meeting certain score values and criteria, etc. The system will also record when and what data has been released or revealed to each entity. The confidential data can be saved locally and/or remotely, such as by cloud storage.

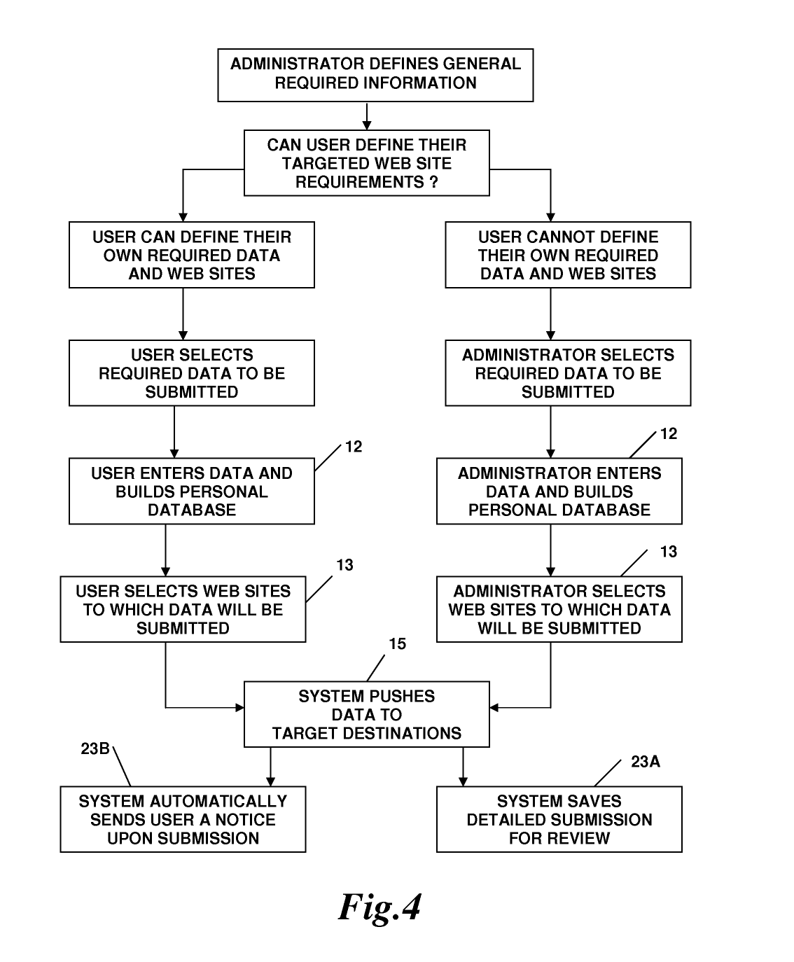

As shown in FIGS. 3 and 4, after the records of the database and the Web Sites (or destinations) to which the data is to be pushed are defined and entered by user (or administrator), the push system analyses the data 14, performs a field check 20, confirms that all data entered are accurate and, by default, returns a warning message 20A for false and a confirmation message 20B for true. The push system contains a structured query language (SQL) program that searches 21 an existing list of Web Sites (or destinations), such as by matching keywords and text parsing of the HTML source code of each Web Site (or destination) to confirm that all destinations are accurate and current and returns a warning message 21A for false and a confirmation message 21B for true, then performs a data matching routine 22 to match the destination requests with the user's entry and returns a warning message 22A for false and a confirmation message 22B for true.

Referring again to FIG. 2, after the push system has completed the analysis and confirmation process, it pushes the user-defined data to the selected destination(s) (Web Sites or destinations) 15, saves a detailed copy to the system memory 23A for the user (or administrator) to review, and sends a summary email to the user (or administrator) 23B.

The only exception to the push process occurs with user (or administrator) entering data in the system user interface 11 and the entered data is inaccurate, or false 20A or not matching the destination requirement 21A. After building a profile, the user may email a link to the profile to anyone, with selected sections being password protected, and selected sections for public view.

It should be noted that although the step of the user (or administrator) defining and entering the destination(s) for submission may take a longer time to initially define all destinations, one skilled in the art will recognize that external software or application may be used to advantage by the present invention. For example, an automatic searching and ranking tool for destination Web Sites can be applied to simplify and speed up the selection process while still allow selective customization.

It should also be understood that although the present invention has been described above for purposes of example, as being used by individuals desiring to apply at a university, that it may be used to advantage for any information pushing requirement, such as for example: a business owner attempting to sell his or her company that enters information into the system, and pushes certain data sequentially and automatically to potential acquirers who meet the business owner's requirements and acquirer's desires; a person searching to find future mates to match potential perfect mates and reveal information according to the rules set by the person; and a person seeking employment and not wanting to reveal certain details unless an acceptable match is found.

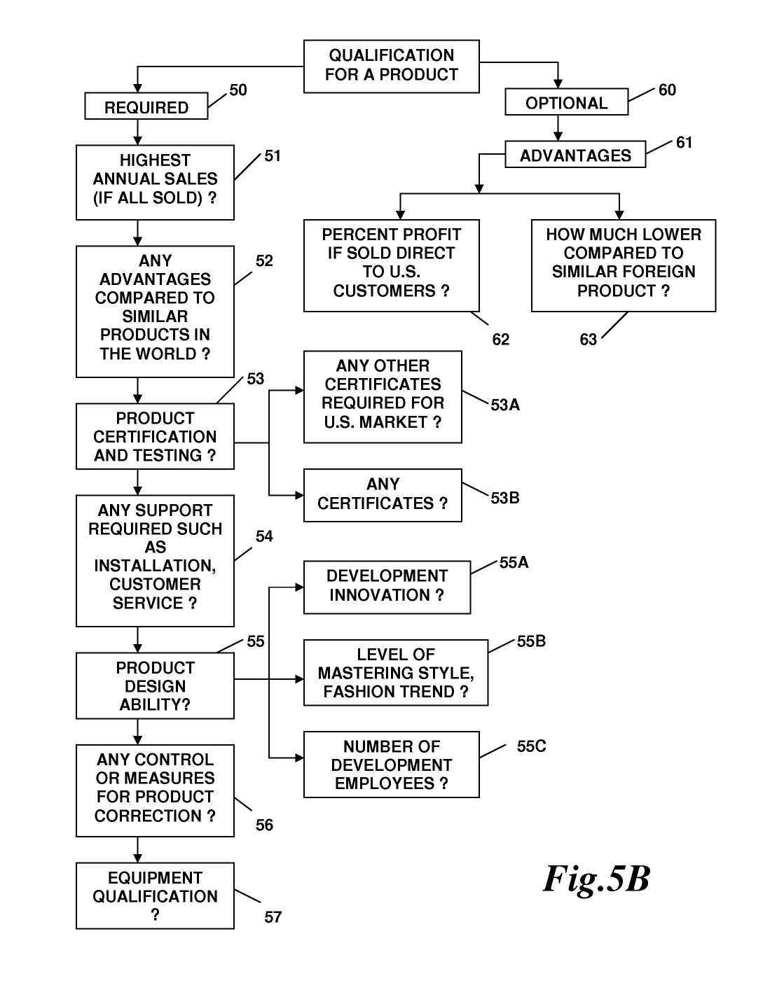

FIG. 5A illustrates an example, but not limited thereto, of the type of information that may be entered at the user interface 11 (described previously) by a business owner attempting to sell a company, and push certain data sequentially and automatically to potential acquirers who meet the business owner's requirements and the acquirer's desires. In this example, the user interface may present the seller with a data entry form with standard and/or customized data fields for entering basic “required” information 30, and “optional” information 40, and for rating the importance of the information. In this example, the basic “required” information 30, includes information regarding “Annual Sales (for the past 3 years)” 31, whether the company possesses “Any Patents” 32, and the type of patents such as “Utility” 32A , “Design” 32B, and “Other” 32C. The “requited” information may also include information “Related to Certain Industry” 33 (for example, cosmetic, medical, biological, children's products, large-scale machinery and equipment, etc.), and whether there are “Established U.S. Sales Channels” 34. The “required” information may also include information regarding “OEM or Brand Sales” 35, and if it is an “Exclusive OEM” 35A, an “OEM For Other Brands” 35B, or it is “Qualified To Sell In The U.S. With Own Brand” 35C. The “required” information may also include “Other Requirements” 36. In this example, the basic “Optional” information 40, includes information regarding the “Estimated Market In The U.S.” 41, the “Number of Target Customers in the top 1,000 of U.S. Market” 42 , and “Other Requirements” 43.

The user may rate the importance of each data set of information. For example, if there are five data sets, and “Annual Sales (for the past 3 years)” 31 is deemed to be the most important criteria, it may be assigned the top priority (1 out of 5), “Patent” information 32 may be deemed second in importance and assigned the second priority (2 out of 5), information regarding “Established U.S. Sales Channels” 34 may be deemed third in importance and assigned the third priority (3 out of 5), etc., with other remaining data sets assigned priorities of importance in proportion to the number of data sets. The user may also rate the importance of each data set of information of the “Optional” information 40 in the same manner.

FIG. 5B illustrates an example, but not limited thereto, of the type of information that may be entered at the user interface 11 (described previously) by a manufacturer attempting to sell a product, and push certain data sequentially and automatically to potential acquirers who meet the manufacturer's requirements and the acquirer's desires. In this example, the user interface may present the seller with a data entry form with standard and/or customized data fields for entering basic “required” information 50, and “optional” information 60, and for rating the importance of the information. In this example, the basic “required” information 50, includes information regarding “Highest Annual Sales (if all products can be sold)” 51, “Any Advantages Compared to Similar Products In The World” 52, whether the product requires “Certification and Testing” 53 and whether there are “Any Other Certificates Required for U.S. Market” 53A or any “Other Certificates” 53B. The “requited” information may also include information as to whether there is “Any Support Required Such As Installation, or Customer Service” 54. The “required” information may also include information regarding “Product Design Ability” 55, and related information such as the level of “Development Innovation” 55A, the “Level Of Mastering Style, or Fashion Trend” 55B, and the “Number of Development Employees” 55C. The “required” information may also include information regarding “Any Control Measures For Product Correction” 56, and “Equipment Qualification” 57. In this example, the basic “Optional” information 60, includes “Advantages” 61, and subcategories of “Percent Profit If Sold Direct To U.S. Customers” 62 and “How Much Lower Compared To Similar Foreign Product” 63.

As with the previous example, the user may rate the importance of each data set of information. For example, if there are seven data sets, and “Certification and Testing” 53 is deemed to be the most important criteria, it may be assigned the top priority (1 out of 7), with other remaining data sets assigned priorities of importance in proportion to the number of data sets. The user may also rate the importance of each data set of information of the “Optional” information 60 in the same manner.

After the user has assigned priorities of importance in proportion to the number of data sets in the examples of qualifying a company (FIG. 5A) and/or qualifying a product (FIG. 5B), as described above, the push system builds a user profile, based on the data and information entered by the user, and defines and ranks Web Sites (or destinations) to which the selected data and information is to be pushed, and saves the entered data in a database in the central processor unit memory. The push system then confirms the user entered data and information, locates and matches Web Site destinations, processes and pushes the data and information to the highest ranked Web Sites, and the system displays the total scores and the results.

The scoring and ranking is based on potential buyers located that match the user's rating of the importance of each data set of information. For example: if the data set was “Related to Certain Industry” 33 (for example, cosmetic, medical, biological, children's products, large-scale machinery and equipment, etc.)“, and the potential buyer was located with matching data, the buyer would receive a score of “100”; if “OEM Or Brand Sales” 35 matched and “Exclusive OEM” 35A was a “Yes”, the potential buyer would receive a score of “100”, etc. These score values are divided by the number of matching data sets assigned priorities of importance by the user to obtain a total score.

It should be understood that the present push system may build user profiles based on selected data and information entered both by users that are seeking to push information to a recipient, and by recipients that are seeking to receive selected data and information. Both types of users may define and rank which selected data and information is to be pushed, or received, and the entered data is stored in a database in the central processor unit memory. The push system then confirms the user entered data and information, processes the information and locates and matches site destinations, and pushes the data and information to the highest ranked destinations, and the system displays the scores and the ranking results, based on potential matches of buyers located that match the user's rating of the importance of each data set of information. The scoring and ranking is based on potential matches of users that are seeking to provide information to a recipient, and by recipients that are seeking to receive selected data and information.

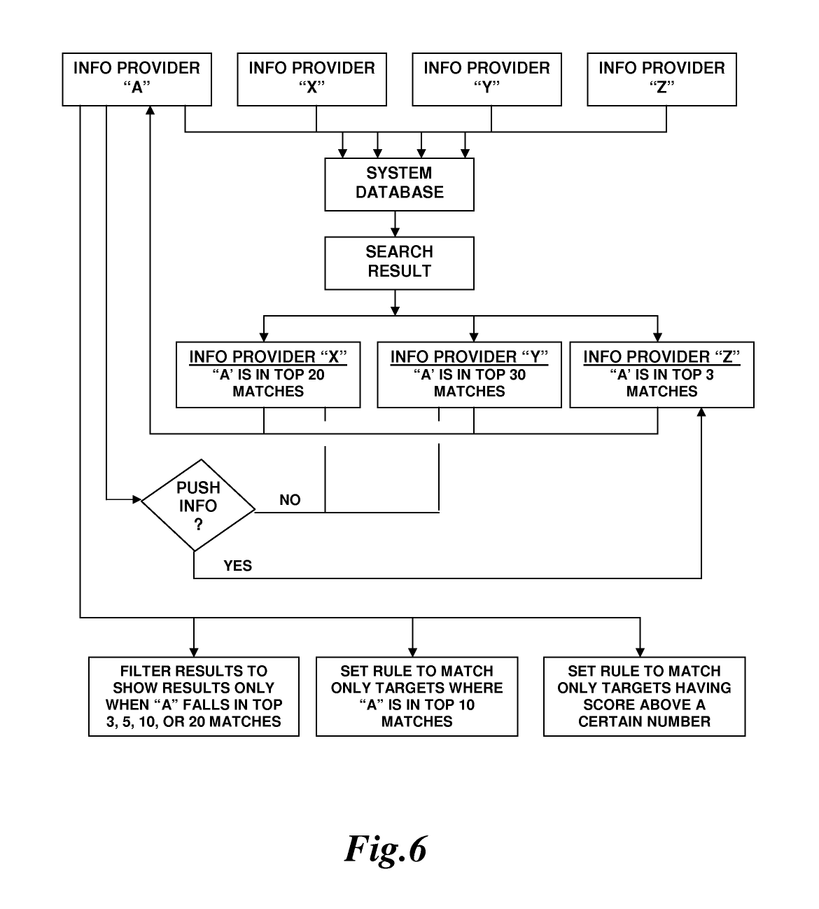

This process is illustrated in FIG. 6. In this example, user “A” (Info Provider “A”) is searching for a target group, and users “X”, “Y” and “Z” (Info Providers X″, “Y” and “Z”) are target groups that are seeking to receive selected data and information. The system will search for matches and display the results based on preferences set by all the information providers. For example, Info Provider “A” searches for a target group, and search results show that Info Providers X″, “Y” and “Z” are the top 3 matches, respectively. However, Info Provider “A” only falls into the top 20 matches on Info Provider “X's” search result, while on Info Provider “Z's” search result, Info Provider “A” is in the top 3 matches. Therefore, even if Info Provider “A” sent information to Info Provider “X”, it is very unlikely “A” will get a response from “X”, but is very likely to get further response if the information is pushed to “Z”. Info Provider “A” may then decide to select “Z” as a priority.

Info Provider “A” can choose to set up a filtration system and only show only results when “A” falls into the potential recipient's top 3, 5, 10 or 20, etc. matches. Info Provider “A” can also set a rule to show matching the best results when: (1) the search result of the targeted group of recipients are in the top 10 on “A's” list, or (2) the total score is higher than a certain number or range set by “A”.

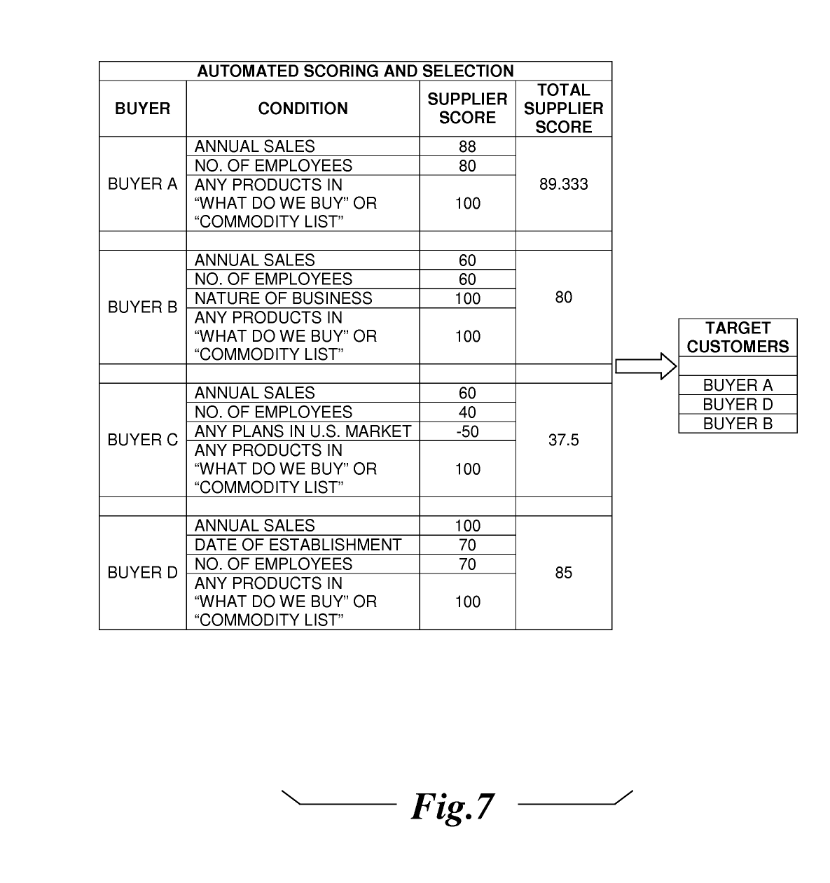

FIG. 7 shows an example of the results of a ranking and scoring routine in a situation where the user wanted to locate a potential buyer for his company or product, and his “required” data set included: “Annual Sales”, “Number of Employees”, “Nature Of Business”, a list of “Products We Buy” or “Commodity List”, “Plans For U.S. Market”, and “Date of Establishment”.

In this example, the system located “Buyer A”, “Buyer B”, “Buyer C”, and “Buyer D”. All four buyers had a matching list of “Products We Buy” or “Commodity List”, and received a score of “100” for that particular data set. In addition Buyer A had data sets matching “Annual Sales” with a score of “88” and “Number of Employees” with a score of “80”, which were rated the top three priorities by the user (seller). Thus, Buyer A received a total score of “89.333” (score values divided by the number of matching data sets assigned highest priorities of importance by the user). Although Buyers B, C, and D had more matching data sets, they received a lower total score because the matching data sets were not assigned highest priorities of importance by the user. The system identified and ranked the three most qualified target customers in order as Buyer A, Buyer D and Buyer B.

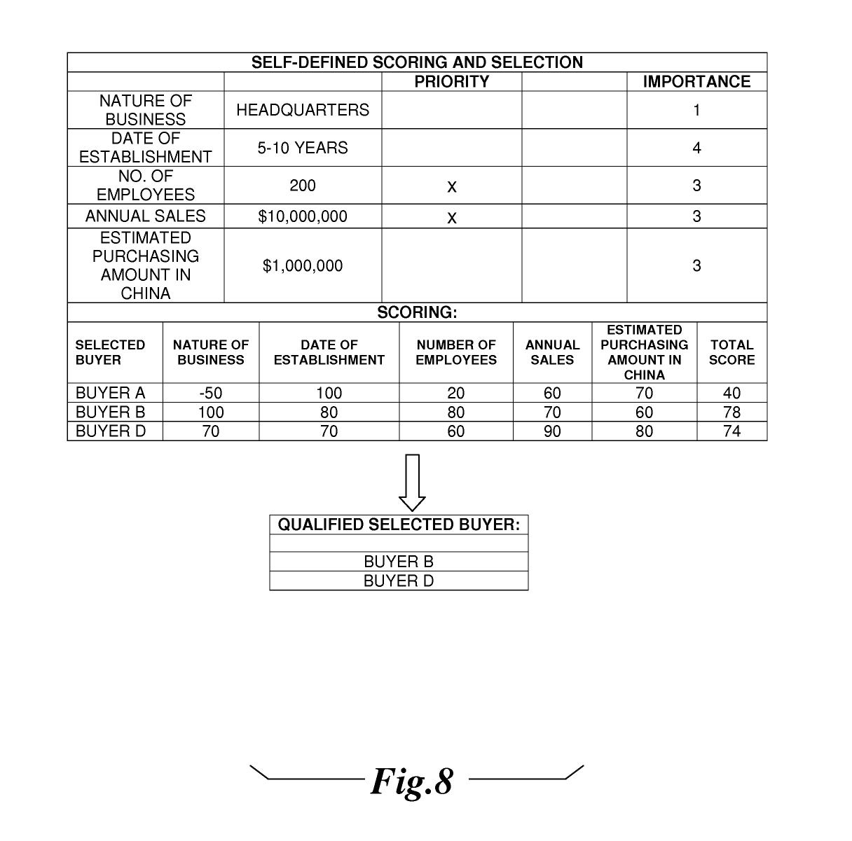

FIG. 8 shows an example of a self-defined ranking and scoring routine where the user wants to locate a potential buyer for his company or product and he defines the conditions of the data sets and ranks them according to “Priority” and “Importance”. The user's “required” data set includes: “Nature Of Business” with a condition of “Headquarters” assigned a value of “1” (1 out of 5) as being of most importance; “Date of Establishment” with a condition of “5-10 Years” assigned a value of “4” (4 out of 5) as being of low importance; “Number of Employees” with a condition of “200” assigned a value of “3” (3 out of 5) as being of medium importance but designated as a “Priority”; “Annual Sales” with a condition of “$10,000,000” assigned a value of “3” (3 out of 5) as being of medium importance but designated as a “Priority”; and “Estimated Purchasing Amount In China” with a condition of “$1,000,000” assigned a value of “3” (3 out of 5) as being of medium importance.

The system located “Buyer A”, “Buyer B”, and “Buyer D”, having a matching list of data sets, but only Buyer B had “Nature Of Business” with a condition of “Headquarters” which was assigned a value of “1” (1 out of 5) as being of most importance to the user. Buyer D had matching “Annual Sales” with a condition of “$10,000,000” which assigned a value of “3” (3 out of 5) as being of medium importance but designated as a “Priority” by the user. The system identified and ranked the two most qualified buyers in order as Buyer B and Buyer D. It should be understood that the user may request the qualified buyers be listed according to either “priority” or “importance”.

In calculating the total score, the ranking and scoring routine may also factor in other additional considerations specified by the user such that the “Total Score” represents a “weighed average” of all the elements, rather than just the simple average of raw score values divided by the number of matches. For example, the range of the “Importance” factor may be given a ceiling of “30”, so that scores won't go above “30”, or given a floor of “80”, so that the important factors are guaranteed to remain important when scoring.

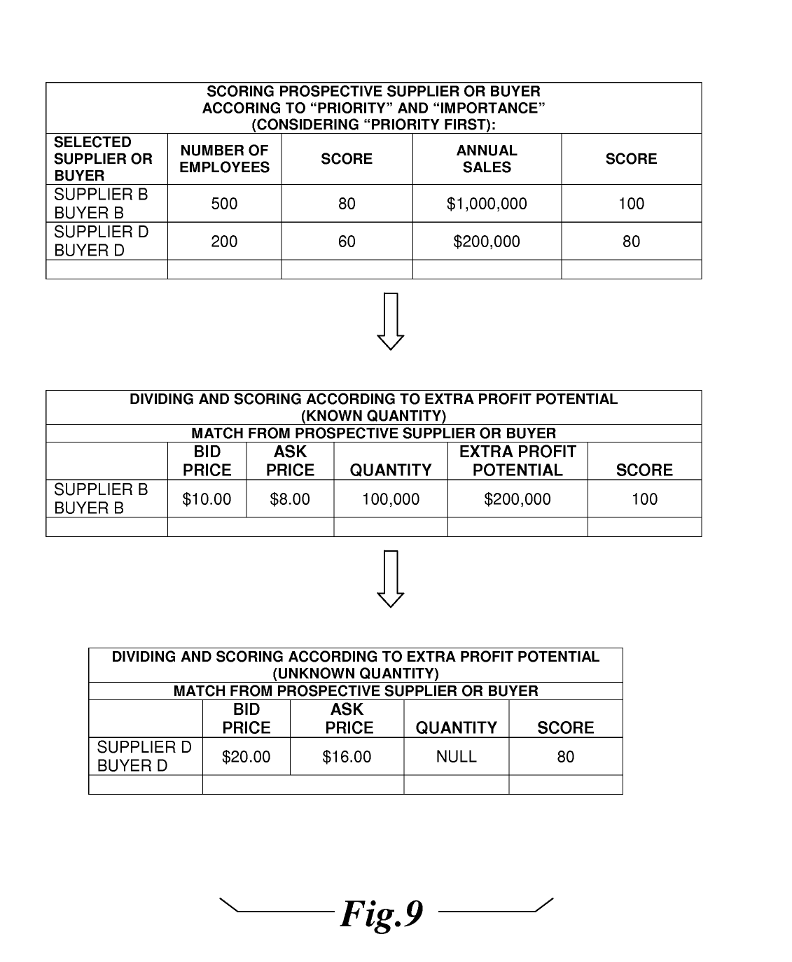

FIG. 9 shows an example of a self-defined ranking and scoring routine which may be used by a prospective product supplier or product buyer to select a matching prospective recipient according to “Priority” and “Importance” considering “Priority” first, for the purpose of acquisition or investment. In this example, Supplier B or Buyer B and Supplier D or Buyer D have been selected as having data sets matching the “Number of Employees” and Annual Sales” according to the users required data sets and “Priority” condition. Supplier B or Buyer B has 500 employees and annual sales of $1,000,000 and Supplier D or Buyer D has 200 employees. Supplier D or Buyer D have annual sales of $200,000. Thus, Supplier B or Buyer B receives a score of “100” and Supplier D or Buyer D receives a score of “80”, as shown in the top chart.

The system may also divide Supplier B or Buyer B and Supplier D or Buyer D and further calculate the extra profit potential resulting from selling or purchasing the products from each supplier or Buyer based on the “Bid Price” (amount a buyer is willing to pay) and the “Ask Price” (amount a seller willing to sell) and whether the “Quantity” is known or unknown.

As shown in the middle chart of FIG. 9, Supplier B or Buyer B has a “Bid Price” of $10 and the “Ask Price” is $8 (a difference of $2) and the “Quantity” is known to be 100,000 units. Thus, the “Extra Profit Potential” is $200,000, and Supplier B or Buyer B receives a score of “100”.

As shown in the bottom chart of FIG. 9, Supplier D or Buyer D has a “Bid Price” of $20 and the Ask Price is $16 (a difference of $4) however, the “Quantity” is unknown. Although the prices are higher and the difference between the “Bid Price” and “Ask Price” is greater, the “Quantity” is unknown and thus the “Extra Profit Potential” is unknown and Supplier D or Buyer D receives a score of “80”.

Although, for purposes of example, the present system has been shown and described as pushing data and information to Web Sites, networks, and servers, it should be understood that the data and information, and links thereto, may be pushed to other destinations, such as third-party email recipients, mobile apps, cell phones, and other portable electronic devices via the World Wide Web, Internet Web Sites, local and/or remote networks, local and/or remote servers, wireless and/or cellular networks, and third-party email addresses.

While the present invention has been disclosed in various preferred forms, the specific embodiments thereof as disclosed and illustrated herein are considered as illustrative only of the principles of the invention and are not to be considered in a limiting sense in interpreting the claims. The claims are intended to include all novel and non-obvious combinations and sub-combinations of the various elements, features, functions, and/or properties disclosed herein. Variations in form, function and manner of operation, assembly and use, are deemed readily apparent and obvious to one skilled in the art from this disclosure, and all equivalent relationships to those illustrated in the drawings and described in the specification are intended to be encompassed in the following claims defining the present invention.

1. A computer-driven and implemented method utilizing push technology with high precision matching based on user-defined values, for managing, storing, transmitting and receiving user data and information stored in a computer workstation having a microprocessor with a local or remote memory component, a graphical user interface coupled with said microprocessor, a user input device coupled with said microprocessor operable by a user for inputting data, a display coupled with said microprocessor for displaying graphics and data, a communications device coupled with said microprocessor for selective communication with the Internet, networks, servers, and other target destinations, and computer readable programs stored thereon, comprising the steps of:
invoking a data entry and processing program implemented in the computer workstation whereby a user creates a user profile and defines specific questions relating to data and information to be transmitted or received, and storing the user profile and questions in the computer workstation memory;
invoking a target destination and qualification tool implemented in the computer workstation whereby the user defines selective prospective target destinations to which selected inputted data and information is to be transmitted, and storing the target destinations in the computer workstation memory;
invoking a data analysis and confirmation tool implemented in the computer workstation to analyze and confirm the accuracy of the user-inputted data and information; and
invoking a data push tool implemented in the computer workstation that searches for and locates prospective target destinations having data and information matching the user-inputted data and information, displays the prospective target destinations, and pushes the data and information to the prospective target destinations.

2. The method according to claim 1, comprising the further steps of:
invoking a scoring and ranking rule construction tool implemented in the computer workstation whereby the user constructs scoring and ranking rules to answers of said questions based on user-defined values, and storing the scoring and ranking rules in the computer workstation memory.

3. The method according to claim 2, wherein
said step of invoking a target destination tool includes user defining selective prospective target destinations to which selected inputted data and information is to be transmitted according to a qualification level based on the scoring and ranking rules and user-defined values, and storing the target destination and qualification levels in the computer workstation memory; and
said data push tool searches for and locates prospective target destinations having data and information matching the user-inputted data and information, displays the prospective target destinations according to the user-defined qualification levels, and scoring and ranking rules, and pushes the data and information to the prospective target destinations according to the user-defined qualification levels and scoring and ranking rules.

4. A computer-driven and implemented method utilizing push technology with high precision matching based on user-defined values, for managing, storing, transmitting and receiving user data and information stored in a computer workstation having a microprocessor with a local or remote memory component, a graphical user interface coupled with said microprocessor, a user input device coupled with said microprocessor operable by a user for inputting data, a display coupled with said microprocessor for displaying graphics and data, a communications device coupled with said microprocessor for selective communication with the Internet, networks, servers, and other target destinations, and computer readable programs stored thereon, comprising the steps of:
invoking a data entry and processing program implemented in the computer workstation whereby a user creates a user profile and defines specific questions relating to data and information to be transmitted or received, and storing the user profile and questions in the computer workstation memory;
invoking a scoring and ranking rule construction tool implemented in the computer workstation whereby the user constructs scoring and ranking rules to answers of said questions based on user-defined values, and storing the scoring and ranking rules in the computer workstation memory;
invoking a target destination and qualification tool implemented in the computer workstation whereby the user defines selective prospective target destinations to which selected inputted data and information is to be transmitted according to a qualification level based on the scoring and ranking rules and user-defined values, and storing the target destination and qualification levels in the computer workstation memory;
invoking a data analysis and confirmation tool implemented in the computer workstation to analyze and confirm the accuracy of the user-inputted data and information;
invoking a data push tool implemented in the computer workstation that searches for and locates prospective target destinations having data and information matching the user-inputted data and information, displays the prospective target destinations according to the user-defined qualification levels, scoring and ranking rules, and pushes the data and information to the prospective target destinations according to the user-defined qualification levels, scoring and ranking rules.

5. The method according to claim 4, wherein
said step of invoking the target destination and qualification tool comprises the user defining selective prospective target destinations to which information is to be sent is selected from the group consisting of the World Wide Web, Internet Web Sites, local and/or remote networks, local and/or remote servers, wireless and/or cellular networks, and third-party email addresses.

6. The method according to claim 4, wherein
said step of invoking the target destination and qualification tool further comprises the user defining rules selected from the group consisting of data pushing times, dates, priorities, customized data submission options, history and retention options, and forwarding options.

7. The method according to claim 4, wherein
said step of invoking the data entry and processing program further comprises the user creating multiple user profiles for different purposes and defines specific questions relating to data and information to be transmitted or received for each profile; and
said step of invoking a target destination and qualification tool further comprises the user defining selective prospective target destinations to which selected inputted data and information is to be transmitted for each profile, respectively.

8. The method according to claim 4, wherein
said step of invoking a target destination and qualification tool further comprises the user entering rules to specify which data and information elements are confidential to selected prospective target destinations, and for selected purposes.

9. The method according to claim 4, wherein
said step of invoking a target destination and qualification tool further comprises the user entering rules to specify that certain data elements are confidential to selected prospective target destinations, and can never be revealed.

10. The method according to claim 4, wherein
said step of invoking a target destination and qualification tool further comprises the user entering rules to specify that certain data elements are confidential to selected prospective target destinations, and can revealed sequentially according to the scoring and ranking rules constructed by the user.

11. The method according to claim 3, wherein
said data analysis and confirmation tool implemented the computer workstation analyzes, performs a data field check to confirm the accuracy of the user-inputted data and information, returns a warning message for inaccurate data or information, and returns a confirmation message for accurate data or information.

12. The method according to claim 4, comprising the further steps of:
after said step of pushing the data and information to said destinations, recording when and what data and information has been submitted to which said destinations, and making the recorded information available to the user.

13. The method according to claim 4, comprising the further step of:
after said step of pushing the data and information to said destinations, generating an email notification of the submission to the user.

14. The method according to claim 4, comprising the further steps of:
after said step of creating a user profile, generating an hypertext link to the user profile for email notification of the user profile with selected sections of the user profile being password protected, and selected sections thereof being available for public view.

15. The method according to claim 1, wherein
said data push tool includes a structured query language (SQL) routine that searches prospective target Web Site, network, and server destinations defined by the user by matching keywords and text parsing of the HTML source code of each destination to confirm that all destination sites are accurate and current and returns a warning message for unconfirmed destinations and a confirmation message for confirmed destinations, then performs a data matching routine to match the confirmed destinations with the data entered by the user and returns a warning message for non-matching destinations and a confirmation message for matching destinations.

16. A computer-driven and implemented selective push system with high precision matching based on user-defined values, for managing, storing, transmitting and receiving user data and information, comprising:
a computer workstation having a microprocessor with a local or remote memory component, a graphical user interface coupled with said microprocessor, a user input device coupled with said microprocessor operable by a user for inputting data, a display coupled with said microprocessor for displaying graphics and data, a communications device coupled with said microprocessor for communication for selective communication with the Internet, networks, servers, and other target destinations,
a computer readable data entry and processing program implemented in said computer workstation configured to allow a user to creates a user profile and define specific questions relating to data and information to be transmitted or received, and store said user profile and questions in said computer workstation memory;
a target destination tool implemented in said computer workstation configured to allow the user to define selective prospective target destinations to which selected inputted data and information is to be transmitted, and store said target destinations in said computer workstation memory;
a data analysis and confirmation tool implemented in said computer workstation configured to analyze and confirm the accuracy of said user-inputted data and information; and
a data push tool implemented in the computer workstation configured to search for and locate prospective target destinations having data and information matching said user-inputted data and information, display the prospective target destinations, and to push said data and information to said prospective target destinations.

17. The system according to claim 16, wherein
said target destination and qualification tool is configured to allow the user to define selective prospective target destinations to which information is to be sent selected from the group consisting of the World Wide Web, Internet Web Sites, local and/or remote networks, local and/or remote servers, wireless and/or cellular networks, and third-party email addresses.

18. The system according to claim 16, further comprising:
a scoring and ranking rule construction tool implemented in said computer workstation configured to allow the user to constructs scoring and ranking rules to answers of said questions based on user-defined values, and store said scoring and ranking rules in said computer workstation memory.

19. The system according to claim 18, wherein
said target destination tool is configured to allow the user to define selective prospective target destinations to which selected inputted data and information is to be transmitted according to a qualification level based on said scoring and ranking rules and user-defined values, and store the target destination and qualification levels said computer workstation memory; and
said data push tool is configured to search for and locate prospective target destinations having data and information matching said user-inputted data and information, display the prospective target destinations according to said user-defined qualification levels, and said scoring and ranking rules, and push the data and information to the prospective target destinations according to said user-defined qualification levels and scoring and ranking rules.
